(19) United States
(12) Patent Application Publication
(10) Pub. No.: US 2007/0122146 A1
(43) Pub. Date: May 31, 2007

(54) Camera module package

(75) Inventor: Jin Mun Ryu, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/602,318

(22) Filed: Nov. 21, 2006

(30) Foreign Application Priority Data
Nov. 28, 2005 (KR) 10-2005-0113970

(51) Int. Cl. G03B 17/00

(52) U.S. Cl. 396/529; 396/542

(57) ABSTRACT

A camera module package using a flip-chip type image sensor module is provided. The camera module package includes: a lens barrel in which a plurality of lenses are stacked and mounted; a housing having an upper opening into which the lens barrel is inserted and mounted; and an image sensor module. The image sensor module includes an image sensor to which bumps are bonded on electrode pads formed on one side; a flexible printed circuit board (FPCB) having via holes formed at positions corresponding to the pads of the image sensor, and conductive patterns formed between layers in which the via holes are formed; and a conductive adhesive filled in the via holes. Accordingly, in manufacturing the COF type image sensor image module, the flip-chip bonding can be achieved only using the conductive adhesive inside the via hole without ACF or NCP, attributing to the microstructure of the camera module. Furthermore, because the relatively expensive ACF or NCP is not used, the camera module can be manufactured at a low cost.

### CROSS-REFERENCE TO RELATED APPLICATIONS

This application claims the benefit of Korean Patent Application No. 2005-113970 filed with the Korea Industrial Property Office on Nov. 28, 2005, the disclosure of which is incorporated herein by reference.

### BACKGROUND OF THE INVENTION

1. Field of the Invention

The present invention relates to a, and more particularly, to a camera module package using a flip-chip image type image sensor module, and more particularly, to a camera module package using a flip-chip image type image sensor module, which can manufacture an ultra-slim camera module having high reliability. When the image sensor is flip-chip-bonded with a flexible printed circuit board (FPCB), bumps formed in the bottom surface of the image sensor are inserted into via holes formed in the FPCB such that the image sensor and the FPCB are electrically connected to each other.

2. Description of the Related Art

With the recent development of mobile terminals such as portable phones and personal digital assistants (PDAs), the mobile terminals provide a phone call function and are used as multi-convergence devices. The most representative of the multi-convergence is a camera module. The resolution of the camera module changes from 300,000 pixels (VGA) to 700,000 pixels. Moreover, the camera module provides various additional functions, such as auto-focusing (AF) and optical zoom.

Generally, compact camera modules (CCMs) are applied to various IT devices, such as camera phones, smart phones, mobile communication terminals, and toy cameras. Recently, products using the CCMs to meet consumers' various tastes are increasingly put on the market.

The camera modules are manufactured by using main parts of charge coupled device (CCD) or complementary metal oxide semiconductor (CMOS) image sensors. Incident light transmitted through the lens is condensed by the image sensor and is stored as data in the memory. The stored data is displayed as an image through a display medium, such as liquid crystal display (LCD) or PC monitor.

Packaging methods of the image sensor for camera module include a chip on film (COF) method using a flip-chip bonding, a chip on board (COB) method using a wire bonding, and a chip select package (CSP). Among them, the COF packaging method and the COB packaging method are widely used.

Hereinafter, the COF packaging structure will be described briefly with reference to FIGS. 1 to 3.

FIG. 1 is an exploded perspective view of a conventional COF type camera module, and FIG. 2 is a partial sectional view of the conventional COF type camera module of FIG. 1.

Referring to FIGS. 1 and 2, the conventional camera module 1 includes an image sensor 3 for converting an image signal inputted through a lens into an electric signal, a housing 2 for supporting the image sensor 3, a lens group 4 for collecting an image signal of an object in the image sensor 3, and a barrel 5 in which the lens group 4 is stacked in multi-layers.

A flexible printed circuit board (FPCB) 6 is electrically connected to a lower portion of the housing 2. Chip components (e.g., condensers and resistors) for driving the CCD or CMOS image sensor 3 are mounted on the FPCB 6.

In the camera module 1, an anisotropic conductive film 8 or non-conductive paste is inserted between the FPCB 6 and the image sensor 3 in such a state that a plurality of circuit components are mounted on the FPCB 6. Then, heat and pressure are applied to electrically attach the FPCB 6 to the image sensor 3, and an IR filter 7 is attached on the FPCB.

Furthermore, in such a state that the barrel 5 and the housing 2 are provisionally screwed to each other, the assembled FPCB 6 is fixed to the bottom surface of the housing 2 by a separate adhesive.

Meanwhile, after the FPCB 6 having the image sensor 3 attached thereto and the barrel 5 are fixed to the housing 2, the focus is adjusted to an object (resolution chart) in front of the barrel 5 at a predetermined distance. In the focus adjustment of the camera module 1, a vertical movement is adjusted by the rotation of the barrel 5 screwed to the housing 2, and the focus adjustment between the lens group 4 and the image sensor 3 is achieved.

Because the COF type camera module package does not need a space for attachment of wires, the package area and the barrel height can be reduced. Therefore, the camera module can be lightweight and slim.

In addition, because a thin film or FPCB is used, the package can be robust against external impact and can be highly reliable, and a manufacturing process of the package can be more simplified. Moreover, the COF type camera module package can attribute to high-speed processing, high density, and multiple pins, due to miniaturization and reduction in resistance.

However, as the COF type camera module package is integrated in a minimum chip size of wafer level package, a manufacturing cost increases and products may not be accurately delivered on the appointed date. Because the conventional COF package has a single-layered structure, the advantages of the miniaturization of the module package are not exhibited in the modules that use mega-pixel image sensors with various functions.

FIGS. 3A and 3B are enlarged sectional views illustrating a method for attaching an FPCB to an image sensor during flip-chip bonding of an image sensor module package. Specifically, FIG. 3A is an enlarged sectional view of the attaching method using ACF, and FIG. 3B is an enlarged sectional view of the attaching method using NCP.

Referring to FIG. 3A, in the flip-chip bonding method using ACF, an ACF 8 is attached on an FPCB 6, and an Au-plated bump 3a is formed in an image sensor 3. Thus, the flip-chip bonding of the image sensor 3 is performed such that the bump 3a contacts the ACF 8. At this point, a conductive ball 8a in the ACF 8 serves as an electrical connector.

Referring to FIG. 3B, in the flip-chip bonding method using NCP, an NPC 9 is coated on a pad 6a of an FPCB 6, and an Au-plated bump 3a or stud bump formed on an image sensor 3 is flip-bonded on the FPCB 6. Because the NCP 9 has no conductive ball 8a , the electrical connection is achieved by directly contacting the bump 3a with the pad 6a of the FPCB 6.

During the image sensor module package using the ACF 8 or the NCP 9, the ACF 8 or the NCP 9 is protruded to the sides of the image sensor module due to the pressing of the FPCB 6 and the image sensor 3 during the flip-chip bonding between the two members. Thus, a flip-chip bonding apparatus may be contaminated, or particles of the externally protruded ACF or NCP may cause the failure of the module or damage the housing.

Furthermore, the flip-chip bonding method using the ACF has to use the conductive balls 8a formed inside the ACF 8. Thus, in the flip-chip process, a relatively high temperature (about 200-240° C.) and pressure (50-150 MPa per bump) have to be applied so as to achieve the bonding.

In the image sensor module package using the flip-chip bonding, a plurality of chip components have to be mounted on the same surface as the surface where the image sensor is attached. Consequently, there is a limitation in minimizing the size of the module package.

### SUMMARY OF THE INVENTION

An advantage of the present invention is that it provides a camera module package using a flip-chip type image sensor module. In the flip-chip bonding of the image sensor on the single-sided or double-sided FPCB, the bumps formed in the bottom surface of the image sensor are directly inserted into the via holes formed in the FPCB. Thus, the FPCB and the image sensor are flip-chip-bonded such that they can be electrically connected to each other.

Additional aspect and advantages of the present general inventive concept will be set forth in part in the description which follows and, in part, will be obvious from the description, or may be learned by practice of the general inventive concept.

According to an aspect of the invention, a flip-chip package of an image sensor module includes: an image sensor in which a plurality of pads are formed on one surface and bumps are bonded to the pads; an FPCB in which via holes are formed at positions corresponding to the pads and patterns are formed at the bottom surface between layers where the via holes are formed; and a conductive adhesive filled in the via holes.

According to another aspect of the present invention, the housing having the lens barrel mounted therein is placed on the upper portion of the image sensor module that is flip-chip-bonded with the bottom surface of the FPCB.

According to a further aspect of the present invention, a plurality of pads are arranged along the outside of the light receiving region defined at the center portion, that is, along the edge of the image sensor. The bonding of the bumps is achieved using capillary in which gold wire is embedded on the pad.

According to a still further aspect of the present invention, the bumps may be solder bump or stud bump.

According to a still further aspect of the present invention, in the center portion of the FPCB to which the image sensor is flip-chip-bonded, the light receiving region of the image sensor is perforated and exposed. A plurality of via holes are formed at positions corresponding to the pads disposed outside the light receiving region.

According to a still further aspect of the present invention, the via holes are composed of blind via holes that provides the electrical interlayer connection by a plurality of patterns formed in the FPCB. The via holes are filled with conductive adhesive.

According to a still further aspect of the present invention, the blind via holes are generally used for connection from the surface layer to the inner layer. In the multi-layered FPCB, the blind via holes connect two or more conductive layers and do not penetrate the FPCB. That is, the FPCB to which the plurality of bumps formed in the image sensor are flip-chip-bonded may be a multi-layered single-sided or double-sided FPCB having interlayer conductive patterns.

According to a still further aspect of the present invention, the via holes are perforated to have a diameter of about 150 μm or less by using laser drilling.

According to a still further aspect of the present invention, Desmear process is performed to chemically remove particles that are generated while burning interlayer polymer of the FPCB during the process of forming the via holes by using the laser drilling. Then, the metal layers are formed on the inner walls of the via holes by a sputtering process and the patterns are formed outside the metal layers.

According to a still further aspect of the present invention, the metal layers interposed between the inner walls of the via holes and the conductive adhesive are formed of conductive lines on both sides of the FPCB. Thus, when the FPCB on which the image sensor module is mounted is used as the double-sided FPCB, the metal lines can be deposited by a separate process.

According to a still further aspect of the present invention, an Ag paste is widely used as the conductive adhesive filled in the via holes. In some cases, carbon paste may be used.

According to a still further aspect of the present invention, via holes are formed on the multi-layered FPCB having the conductive patterns within the interlayer. The bumps bonded on the pads formed on one surface of the image sensor are directly docked into the via holes, thereby achieving the flip-chip bonding. Thus, when the image sensor and the FPCB are electrically connected to each other, the flip-chip bonding can be achieved without applying additional heat and pressure. Furthermore, the package size can be minimized.

According to a still further aspect of the present invention, a method for manufacturing a flip-chip package of an image sensor includes: forming a plurality of bums on a plurality of pads disposed on one surface of the image sensor; forming via holes for interlayer connection on an FPCB having interlayer conductive patterns; filling the via holes with conducive adhesive; and inserting the bumps of the image sensor into the via holes of the FPCB such that the bumps and the via holes are electrically connected.

According to a still further aspect of the present invention, when the FPCB is the double-sided FPCB, the manufacturing method further includes: forming via holes on one of both sides of the double-sided FPCB by laser drilling; and forming metal layers on inner walls of the via holes using a sputtering process.

According to a still further aspect of the present invention, the metal layers formed inside the via holes are formed of titanium (Ti) or gold (Au).

According to a still further aspect of the present invention, the conductive adhesive is filled on the metal layers by screen printing.

According to a still further aspect of the present invention, when the flip-chip bonding is achieved by inserting the bumps of the image sensor into the via holes, the conductive adhesive filled in the via holes is hardened. The conductive adhesive can be hardened by applying heat using a jig, or by using an oven heated to about 120° C.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective of a conventional COF type camera module;

FIG. 2 is a sectional view of the conventional COF type camera module of FIG. 1

FIGS. 3A and 3B are enlarged sectional views illustrating a method for attaching a board to a sensor during flip-chip bonding of an image sensor module package;

FIG. 3A is an enlarge sectional view of the attaching method using ACF;

FIG. 3B is an enlarged sectional view of the attaching method using NCP;

FIGS. 4A to 6 are views of a flip-chip package of an image sensor module according to a first embodiment of the present invention;

FIG. 4A is a plan view of an image sensor;

FIG. 4B is a partially enlarged sectional view of the image sensor of FIG. 4A;

FIG. 5A is a plan view of an FPCB;

FIG. 5B is a partially enlarged sectional view of the FPCB of FIG. 5A;

FIG. 6 is a sectional view of the image sensor module package according to the first embodiment of the present invention;

FIGS. 7 to 9 are views of a flip-chip module package of an image sensor module according to a second embodiment of the present invention;

FIG. 7A is a plan view of an image sensor;

FIG. 7B is a partially enlarged sectional view of the image sensor of FIG. 7A;

FIG. 8A is a plan view of an FPCB;

FIG. 8B is a partially enlarged sectional view of the FPCB of FIG. 8A;

FIG. 9 is a sectional view of the image sensor module package according to the second embodiment of the present invention;

FIGS. 10A and 10B are sectional views of a camera module package using a flip-chip bonding;

FIG. 10A is a sectional view of a camera module package using a single-sided FPCB; and

FIG. 10B is a sectional view of a camera module package using a double-sided FPCB.

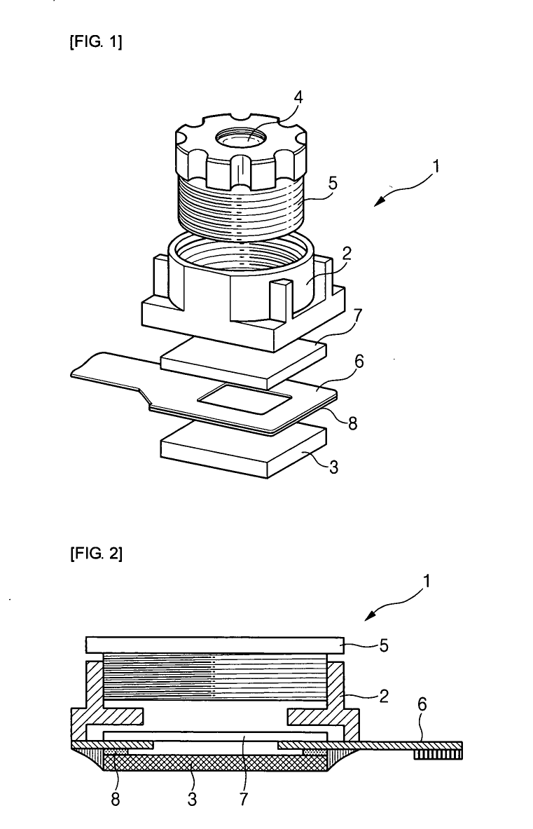

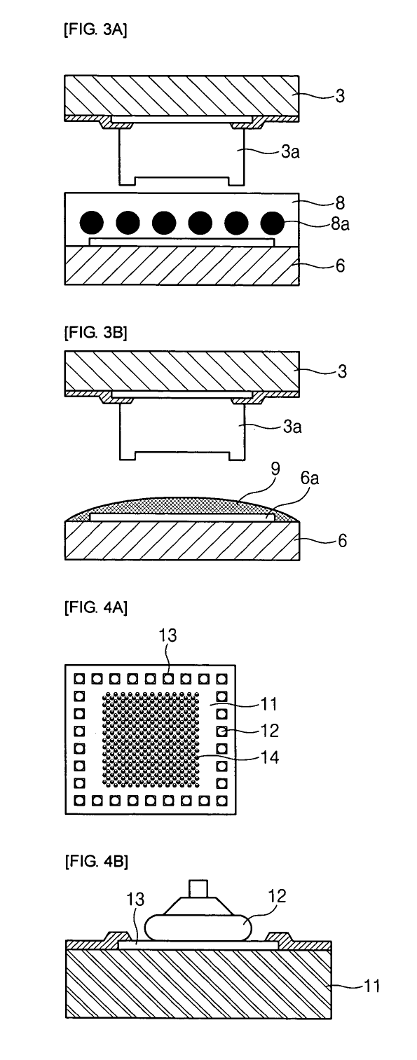

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Flip-Chip Package Structure of Image Sensor Module

### Embodiment 1

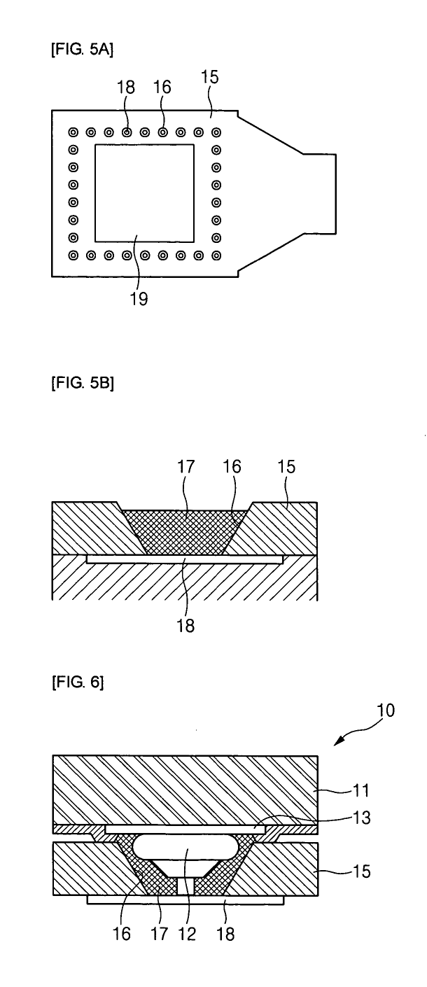

FIGS. 4 to 6 are views illustrating a flip-chip package of an image sensor module according to a first embodiment of the present invention. Specifically, FIG. 4A is a plan view of an image sensor, FIG. 4B is a partially enlarged sectional view of the image sensor of FIG. 4A, FIG. 5A is a plan view of an FPCB, FIG. 5B is a partially enlarged sectional view of the FPCB of FIG. 5A, and FIG. 6 is a sectional view of the image sensor module according to the first embodiment of the present invention.

Referring to FIGS. 4 to 6, the flip-chip package 10 of the image sensor module includes an image sensor 11 and an FPCB 15. The image sensor 11 has a plurality of bumps 12 protruded at one surface thereof. The FPCB 15 has a plurality of via holes 16 formed at positions corresponding to the bumps 12, and conductive adhesive 17 is filled in the via holes 16.

The image sensor 11 includes a light receiving region 14 at the center portion thereof. A plurality of pads 13 are arranged at an outer edge of the light receiving region 14. The bumps 12 are formed of conductive material and protrudingly connected on the pads 13.

The bumps 12 are fixedly attached on the pads 13 by capillary phenomenon using capillaries with a built-in gold wire. The bumps 12 are formed in a stud bump or plated bump type. The bumps 12 come in contact with surfaces of the FPCB 15 in which the via holes 16 are formed. Thus, the image sensor 11 can be electrically connected by the bumps 12.

The FPCB 15 to which the image sensor 11 is flip-chip-bonded is provided with a multi-layered substrate having a plurality of interlayer conductive patterns 18. The plurality of via holes 16 are formed on one side of the FPCB 15 so that a single-layered polymer is penetrated. The via holes 16 are formed at the positions corresponding to the attached positions of the bumps 12, that is, at the outer edge of the light receiving region 19 of the center portion perforated to expose the light receiving region 19 upward during the flip-chip bonding of the image sensor 11. The via holes 16 are connected to the bumps 12 in 1:1 correspondence.

The via holes 16 form a blind via hole that can be electrically connected by the plurality of pads 18 embedded in the multi-layered FPCB 15. Due to the circuit patterns 18 formed at lower portions of the via holes 16, the electrically connectable via holes 16 can be formed without penetrating the lower and upper portions of the multi-layered FPCB 15.

The FPCB 15 having the via holes 16 may be a single-layered FPCB, a multi-layered FPCB, a rigid flexible PCB, or a built-up PCB.

In addition, the degree of design freedom of the FPCB 15 can be increased by the circuit patterns 18, which are embedded in the FPCB to correspond to all the via holes 16, thereby minimizing the substrate size.

Furthermore, the via holes 16 formed in the FPCB 15 are perforated to have a diameter of about 150 μm or less by using laser drilling. Then, Desmear process is performed to remove particles that are generated inside and around the via holes 16 during the laser drilling process, and the via holes 16 are filled with the conductive adhesive 17 by screen printing.

The conductive adhesive 17 printed inside the via holes 16 may be silver (Ag)-based metallic material, preferably, Ag epoxy, Ag paste, and carbon paste containing solder cream.

Preferably, the via holes 16 formed in the FPCB 15 are perforated in a corn shape in which an upper diameter is greater than a lower diameter. The reason for this is that the bumps 12 docked through the upper portion of the via holes 16 can be smoothly connected along the inclined side surfaces of the via holes 16.

In the flip-chip module of the image sensor according to the present invention, the plurality of via holes 16 are formed on the uppermost surface of the FPCB 15 such that they are electrically conductive, and the conductive adhesive 17 is printed inside the via holes 16. Through these procedures, the FPCB 15 for the flip-chip bonding of the image sensor 11 is prepared.

In the image sensor 11, the pads 13 are formed at the positions corresponding to the surface where the via holes 16 are formed, and the bumps 12 are protruded on the pads 13. The image sensor 11 is flip-chip-bonded with the FPCB 15. The via holes 16 of the FPCB 15 and the bumps 12 of the image sensor 11 are respectively formed at the positions facing the members 11 and 15 such that they can be connected in 1:1 correspondence. Thus, the bumps 12 are docked into the via holes 16, thereby achieving the flip-chip bonding.

### Embodiment 2

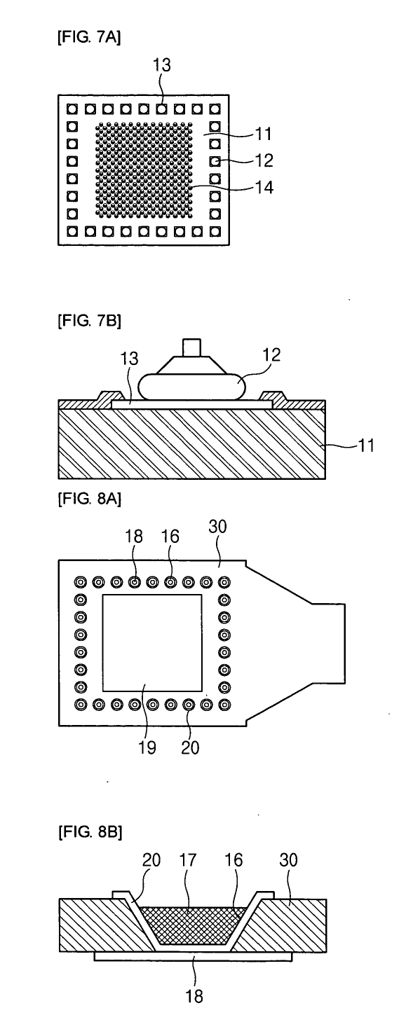

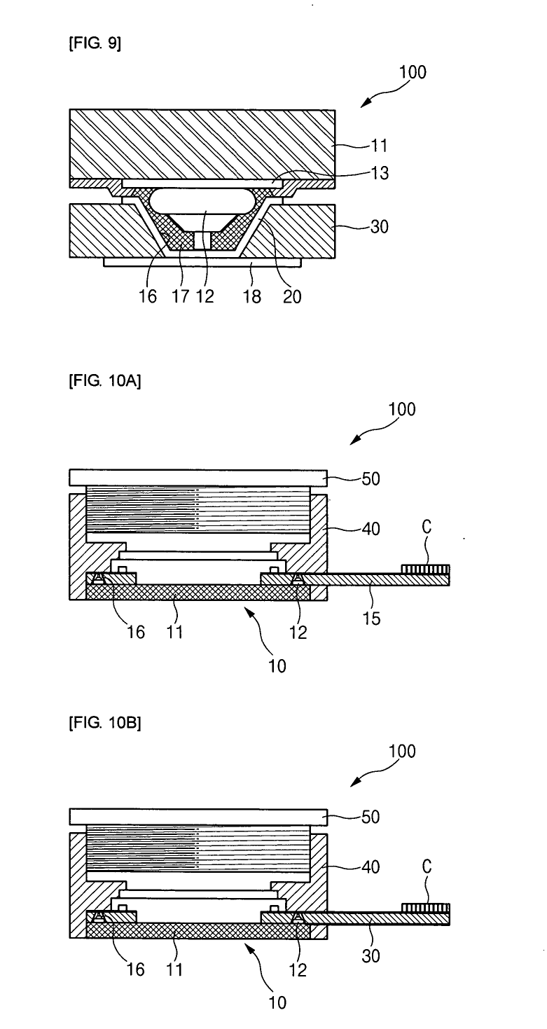

FIGS. 7 to 9 are views illustrating a flip-chip package of an image sensor module according to a second embodiment of the present invention. Specifically, FIG. 7A is a plan view of an image sensor, FIG. 7B is a partially enlarged sectional view of the image sensor of FIG. 7A, FIG. 8A is a plan view of an FPCB, FIG. 8B is a partially enlarged sectional view of the FPCB of FIG. 8A, and FIG. 9 is a sectional view of the image sensor module according to the second embodiment of the present invention.

Detailed description about the duplicate technical structure will be omitted. The same reference numerals are used to refer to the same elements throughout the drawings.

Referring to FIGS. 7 to 9, the flip-chip package 10 of the image sensor module includes an image sensor 11 and a double-sided FPCB 30. The image sensor 11 has a plurality of bumps 12 protruded at one surface. The FPCB 30 has a plurality of via holes 16 formed at positions corresponding to the bumps 12, and metal layers 20 is deposited on inner walls of the via holes 16.

A conductive adhesive 17 is filled in the metal layers 20 by screen printing.

The FPCB 30 to which the image sensor 11 is flip-chip-bonded is formed of a multi-layered double-sided FPCB with a plurality of interlayer conductive patterns 18. The plurality of via holes 16 are formed on one side of the FPCB 30 so that a single-layer polymer is penetrated. The via holes 16 are formed at the positions corresponding to the attached positions of the bumps 12, that is, at the outer edge of the light receiving region 19 of the center portion perforated to expose the light receiving region 19 upward during the flip-chip bonding of the image sensor 11. The via holes 16 are connected to the bumps 12 in 1:1 correspondence.

85 The via holes 16 may be selectively formed on one of the two surfaces of the FPCB 30.

The FPCB 30 having the via holes 16 may be a single-layered FPCB, a multi-layered FPCB, a rigid flexible PCB, or a built-up PCB.

In addition, the via holes 16 formed on the surface of the FPCB 30 are perforated to have a diameter of about 150 μm or less by using laser drilling. Then, Desmear process is performed to remove particles that are generated inside and around the via holes 16 during the laser drilling process. The metal layers 20 are formed on the inner walls of the via holes 16 by a sputtering process and are patterned outside the metal layers 20. The conductive adhesive 17 is filled on the metal layers 20 deposited on the inner walls of the via holes 16 by screen printing.

The conductive adhesive 17 printed inside the via holes 16 may be silver (Ag)-based metallic material, preferably, Ag epoxy, Ag paste, and carbon paste containing solder cream.

In the flip-chip package of the image sensor module according to the present invention, the plurality of via holes 16 are formed in the uppermost surface of the FPCB 30 having the conductive circuit patterns 18 between the layers, such that they are electrically conductive. The metal layers 20 are deposited for forming the additional conductive lines on the inner walls of the via holes 16. In addition, the conductive adhesive 17 is printed inside the via holes 16. Through these procedures, the FPCB 30 for the flip-chip bonding of the image sensor 11 is prepared. Subsequently, the image sensor module package is manufactured through the same process as those of the first embodiment of the present invention.

The structure of the image sensor module package according to the present invention can be applied to the flip-chip semiconductor package and a method for manufacturing the same.

Structure of Camera Module

FIGS. 10A and 10B are sectional views of a camera module package using a flip-chip bonding. Specifically, FIG. 10A is a sectional view of a camera module package using a single-sided FPCB, and FIG. 10B is a sectional view of a camera module package using a double-sided FPCB.

Referring to FIGS. 10A and 10B, the camera module 100 includes a lens barrel 50, a housing 40, and an image sensor module 10. The lens barrel 50 is inserted from an opening of the housing 40 and are mounted therein. The image sensor module 10 is connected to a lower opening of the housing 40.

The housing 40 is a supporting member and has the upper and lower openings. The housing 40 is connected to the image sensor 30 and the lens barrel 50, which will be described later.

The lens barrel 50 is connected to the upper opening of the housing 40 and serves as a lens holder. The lens barrel 50 is formed of resin such as polycarbonate, and aperture and condensing lens are installed in the bottom of the lens barrel 50 inserted into the housing 40. In addition, IR coated glass is attached on the lens barrel 50 and prevents foreign particles from being penetrated toward the aperture or the condensing lens.

The image sensor module 30 connected to the lower opening of the housing 40 includes a single-sided FPCB 15 or double-sided FPCB 30 and an image sensor 11. The single-sided FPCB 15 or the double-sided FPCB 30 includes a light receiving region 19 in which light passing through a lens provided inside the lens barrel is condensed. The image sensor 11 processes the condensed light and is attached to one surface of the FPCB 15 or 30 by flip-chip boning. A free end of the FPCB 15 or 30 is connected to a connector C.

The image sensor 11 has the same width as that of the FPCB 15 or 30 and is attached to one surface (bottom surface) of the FPCB 15 or 30. A plurality of electrode pads are formed on the surface to which one surface of the FPCB 15 or 30 is attached. The bumps 12 formed on the electrode pads are formed on the corresponding surface of the FPCB 15 or 30. The image sensor 11 is closely attached to the bottom surface of the FPCB 15 or 30, without ACF or NCP, by the flip-chip bonding in which the bumps 12 are inserted into the via holes 16 filled with the conductive adhesive 17.

Since the flip-chip bonding between the FPCB 15 or 30 and the image sensor 11 has been described in detail in the first and second embodiments of the present invention, its detailed description will be omitted.

Method for Manufacturing Flip-chip Package of Image Sensor

Hereinafter, a method for manufacturing the image sensor module package for the camera module will be described in detail.

Bumps 12 are formed on a plurality of electrode pads 13 provided in one surface of the image sensor 11. Via holes 16 are formed in the FPCB 15 having conductive patterns 18 between layers.

The via holes 16 are filled with conductive adhesive 17. Then, the bumps 12 formed on one surface of the image sensor 11 are inserted into the via holes 16 of the FPCB 15, and the conductive adhesive 17 filled in the via holes 16 is hardened by applying heat using a jig or oven. Through these procedures, the flip-chip package of the image sensor module is prepared.

When the FPCB 15is the double-sided FPCB 30 just like in the second embodiment of the present invention, the manufacturing method further includes: forming via holes 16 on one of both sides of the double-sided FPCB 30 by laser drilling; and forming metal layers 20 on inner walls of the via holes 16 using a sputtering process.

Preferably, the metal layers 20 formed inside the via holes 16 are formed of titanium (Ti) or gold (Au). The conductive adhesive 17 is filled on the metal layers 20 by screen printing.

In the camera module package using the flip-chip type image sensor module according to the present invention, the bumps formed in the bottom surface of the image sensor are directly inserted into the via holes formed in the single-sided or double-sided FPCB. Thus, the FPCB and the image sensor are flip-chip-bonded such that they can be electrically connected to each other. Therefore, in manufacturing the COF type image sensor image module, the flip-chip bonding can be achieved only using the conductive adhesive inside the via hole without ACF or NCP, attributing to the microstructure of the camera module. Furthermore, because the relatively expensive ACF or NCP is not used, the camera module can be manufactured at a low cost.

Moreover, because the bumps formed in the image sensor is directly inserted into the via holes of the FPCB, the assembly reliability of the image sensor module package can be enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A camera module package comprising:
a lens barrel in which a plurality of lenses are stacked and mounted;
a housing having an upper opening into which the lens barrel is inserted and mounted; and
an image sensor module including:
an image sensor to which bumps are bonded on electrode pads formed on one side;
a flexible printed circuit board (FPCB) having via holes formed at positions corresponding to the pads of the image sensor, and conductive patterns formed between layers in which the via holes are formed; and
a conductive adhesive filled in the via holes.

2. The camera module package according to claim 1,
wherein the image sensor module includes metal layers deposited on inner walls of the via holes formed in the FPCB.

3. The camera module package according to claim 2,
wherein the metal layers formed in the via holes are formed of one of titanium (Ti) and gold (Au).

4. The camera module package according to claim 1,
wherein the via holes are blind via holes electrically connected by a plurality of patterns formed between the layers of the FPCB.

5. The camera module package according to claim 1,
wherein the via holes are perforated by laser drilling and have a diameter of 150 μm or less.

6. The camera module package according to claim 1,
wherein the conductive adhesive is filled on the metal layers within the via holes by screen printing.
